(19) United States
(12) Patent Application Publication
(10) Pub. No.: US 2026/0098739 A1
(43) Pub. Date: Apr. 9, 2026

(54) STRUCTURED SHARED AUTOMOTIVE TRAVEL

(71) Applicant: Tawainga W. Katsvairo, Tallahassee, FL (US)

(72) Inventor: Tawainga W. Katsvairo, Tallahassee, FL (US)

(21) Appl. No.: 18/921,198

(22) Filed: Oct. 21, 2024

Related U.S. Application Data
(60) Provisional application No. 63/703,938, filed on Oct. 5, 2024.

(51) Int. Cl. G01C 21/34; G06Q 50/43

(52) U.S. Cl. CPC G01C 21/3484; G06Q 50/43

(57) ABSTRACT

Methods, systems, devices, and products for managing shared automotive travel. Methods include accessing a database associating ride constraint information with each rider of a plurality of potential riders to identify a cluster of riders from the plurality wherein the values for the at least one ride constraint parameter from the associated ride constraint information for the cluster meet a similarity threshold; determining a route for motor vehicle travel for at least a first rider and a second rider of the cluster in dependence upon at least the value for the at least one ride constraint parameter associated with the first rider and the value for the at least one ride constraint parameter associated with the second rider; associating the route with a trip; and providing a notification of the trip to at least the first rider and the second rider.

### CROSS-REFERENCES TO RELATED APPLICATIONS

This application claims priority from United States Provisional Patent Application Ser. No. 63/703,938, filed on 5 Oct. 2024, incorporated herein by reference in its entirety.

### FIELD OF THE DISCLOSURE

This disclosure generally relates to ride sharing, and in particular, to methods and systems for optimizing shared automobile travel for convenience and efficiency by enabling trips shared by groups derived from a large pool of riders. In particular, aspects of the disclosure include methods and systems for managing shared automotive travel. More particularly, some aspects of the disclosure relate to methods and systems adapted to manage shared automotive travel for riders commuting or otherwise traveling on a regular basis or other pre-planned shared automobile travel.

### BACKGROUND OF THE DISCLOSURE

Ride-sourcing systems utilize computers and mobile communication devices to provide flexible, personalized transportation services. A customer can transmit a request for transport from a given customer geographic location. A service carried out by a computer program may handle the request by selecting a party to provide transport to the customer, based on vehicle location parameters such as the location of the driver or a vehicle of the transporting party. Individual drivers may be selected in response to a customer request. A selected driver may have the option to accept the assignment (e.g., claim the ride as a driver). Once a driver is assigned (e.g., is selected and has accepted the assignment), information about the driver (e.g. driver location, driver picture, rating, and so on) may be communicated to a device of the customer (e.g., a mobile telephone). The geographic location of the respective parties may be determined by software executing on a computing device having geo-aware resources.

### SUMMARY OF THE DISCLOSURE

In aspects, the present disclosure is related to methods and systems for optimizing shared automobile travel, carried out by identifying a cluster of riders suitable for shared automotive travel from a plurality of potential riders in dependence upon ride constraint information associated with each rider of the plurality of potential riders.

Aspects of the disclosure include computer-implemented methods for managing shared automotive travel. These methods may be carried out by accessing a database associating ride constraint information with each rider of a plurality of potential riders, the ride constraint information for each rider comprising a value for at least one ride constraint parameter, to identify a cluster of riders from the plurality of potential riders wherein the values for the at least one ride constraint parameter from the associated ride constraint information for the cluster of riders meet a similarity threshold; determining a route for motor vehicle travel for at least a first rider and a second rider of the cluster in dependence upon at least the value for the at least one ride constraint parameter associated with the first rider and the value for the at least one ride constraint parameter associated with the second rider; associating the route with a trip; and providing a notification of the trip to at least the first rider and the second rider. The first ride constraint information and the second ride constraint information are non-identical.

In some aspects, determining the route comprises determining the route for a subset of the cluster in dependence upon at least upon ride constraint information associated with each rider of the subset. In some aspects, determining the route comprises determining the route for the cluster in dependence upon at least upon ride constraint information associated with each rider of the cluster.

Methods may further comprise identifying a third rider not in the cluster from the plurality of potential riders that is within a distance metric threshold of the route in dependence upon ride constraint information in the database associated with the third rider, and notifying the third rider of the trip. Methods may further comprise identifying a third rider not in the cluster from the plurality of potential riders that is within a distance metric threshold of the route in dependence upon ride constraint information in the database associated with the third rider, and providing the route to the third rider. Methods may further comprise providing the route to a driver. Methods may further comprise providing the route to at least the first rider and the second rider of the trip. Methods may further comprise providing the route to a vehicle associated with the trip.

The constraint information may include first origin location information associated with a first rider of the plurality of potential riders and indicative of a first pickup location constraint for the first rider; first origin time information associated with the first rider and indicative of a first pickup time constraint for the first rider; first destination location information associated with the first rider and indicative of a first drop-off location constraint for the first rider; first destination time information associated with the first rider and indicative of a first drop-off time constraint for the first rider; second origin location information associated with a second rider of the plurality of potential riders and indicative of a second pickup location constraint for the second rider; second origin time information associated with the second rider and indicative of a second pickup time constraint for the second rider; second destination location information associated with the second rider and indicative of a second drop-off location constraint for the second rider; and second destination time information associated with the second rider and indicative of a second drop-off time constraint for the second rider.

In embodiments, the value for the at least one ride constraint parameter may comprise a value for multiple ride constraint parameters, such as a value for a first ride constraint parameter, a value for a second ride constraint parameter, and a value for at least one other ride constraint parameter. These ride constraint parameters, which may be processed in any order, may include origin location parameters, origin time parameters, destination location parameters, and destination time parameters. In instances, identifying the cluster of riders may include: processing the values for the first ride constraint parameter associated with each rider of the plurality of potential riders to generate a first preliminary cluster based on similarity of the values for the first ride constraint parameter; processing the values for the second ride constraint parameter associated with each rider of the first preliminary cluster to generate a second preliminary cluster based on similarity of the values for the second ride constraint parameter; and processing the values for the at least one other ride constraint parameter associated with each rider of the second preliminary cluster to identify the cluster of riders.

Aspects of the disclosure include computer-implemented methods for managing shared automotive travel carried out by accessing a database associating ride constraint information with each rider of a plurality of potential riders to identify a cluster of riders for shared use of an automobile from the plurality of potential riders in dependence upon first ride constraint information for a first rider and second ride constraint information for a second rider; determining a route for the automobile in dependence upon the first ride constraint information and the second ride constraint information; associating the route with a trip; identifying a third rider from the plurality of potential riders that is within a distance metric threshold of the route in dependence upon ride constraint information associated with the third rider; and providing a notification of the trip to at least the first rider, the second rider, and the third rider.

The constraint information may comprise first origin location information associated with a first rider of the plurality of potential riders and indicative of a first pickup location constraint for the first rider; first origin time information associated with the first rider and indicative of a first pickup time constraint for the first rider; first destination location information associated with the first rider and indicative of a first drop-off location constraint for the first rider; first destination time information associated with the first rider and indicative of a first drop-off time constraint for the first rider; second origin location information associated with a second rider of the plurality of potential riders and indicative of a second pickup location constraint for the second rider; second origin time information associated with the second rider and indicative of a second pickup time constraint for the second rider; second destination location information associated with the second rider and indicative of a second drop-off location constraint for the second rider; and second destination time information associated with the second rider and indicative of a second drop-off time constraint for the second rider.

Aspects of the disclosure include computer-implemented methods for managing shared automotive travel carried out by accessing a database associating ride constraint information with each rider of a plurality of potential riders to identify a cluster of riders for shared use of an automobile from the plurality of potential riders in dependence upon constraint information, determining a route for the automobile, associating the route with a trip, identifying a third rider from the plurality of potential riders that is within a distance metric threshold of the route in dependence upon ride constraint information associated with the third rider, and providing a notification of the trip to at least the first rider, the second rider, and the third rider; the constraint information comprising: first origin location information associated with a first rider of the plurality of potential riders and indicative of a first pickup location constraint for the first rider; first origin time information associated with the first rider and indicative of a first pickup time constraint for the first rider; first destination location information associated with the first rider and indicative of a first drop-off location constraint for the first rider; first destination time information associated with the first rider and indicative of a first drop-off time constraint for the first rider; second origin location information associated with a second rider of the plurality of potential riders and indicative of a second pickup location constraint for the second rider; second origin time information associated with the second rider and indicative of a second pickup time constraint for the second rider; second destination location information associated with the second rider and indicative of a second drop-off location constraint for the second rider; and second destination time information associated with the second rider and indicative of a second drop-off time constraint for the second rider. Determining the route may be carried out by determining the route for the automobile in dependence upon at least: the first origin location information; the first origin time information; the first destination location information; the first destination time information; the second origin location information; the second origin time information; the second destination location information; and the second destination time information.

The route may include a first pick-up location for the first rider, a second pick-up location for the second rider, a first drop-off location for the first rider and a second drop-off location for the second rider. The ride constraint information may include: first origin location information associated with a first rider of the plurality of potential riders and indicative of a first pickup location constraint for the first rider; first origin time information associated with the first rider and indicative of a first pickup time constraint for the first rider; first destination location information associated with the first rider and indicative of a first drop-off location constraint for the first rider; first destination time information associated with the first rider and indicative of a first drop-off time constraint for the first rider; second origin location information associated with a second rider of the plurality of potential riders and indicative of a second pickup location constraint for the second rider; second origin time information associated with the second rider and indicative of a second pickup time constraint for the second rider; second destination location information associated with the second rider and indicative of a second drop-off location constraint for the second rider; and second destination time information associated with the second rider and indicative of a second drop-off time constraint for the second rider. Methods of the present disclosure may include associating the route with a trip. Methods of the present disclosure may include providing a notification of the trip to at least the first rider and the second rider. Methods of the present disclosure may include associating the route with at least the first rider and the second rider.

Aspects of the present disclosure include methods for optimizing shared automobile travel, carried out by identifying a cluster of riders suitable for shared automotive travel including at least a first rider and a second rider from a plurality of potential riders in dependence upon ride constraint information associated with each rider of the plurality of potential riders including at least first ride constraint information associated with the first rider and second ride constraint information associated with the second rider, the second ride constraint information different from the first ride constraint information; determining a route for motor vehicle travel, the route associated with at least the first rider and the second rider of the cluster, in dependence upon at least the first ride constraint information and the second ride constraint information to enable pickup and drop-off of at least the first rider and the second rider along the route; associating the route with a trip; and providing a notification of the trip to at least the first rider and the second rider.

Aspects of the present disclosure include methods for optimizing travel for riders of motor vehicles, including: identifying a cluster of riders for shared use of an automobile from a plurality of potential riders in dependence upon at least: first origin location information associated with a first rider of the plurality of potential riders and indicative of a first pickup location constraint for the first rider, first origin time information associated with the first rider and indicative of a first pickup time constraint for the first rider, first destination location information associated with the first rider and indicative of a first drop-off location constraint for the first rider, first destination time information associated with the first rider and indicative of a first drop-off time constraint for the first rider, second origin location information associated with a second rider of the plurality of potential riders and indicative of a second pickup location constraint for the second rider, second origin time information associated with the second rider and indicative of a second pickup time constraint for the second rider, second destination location information associated with the second rider and indicative of a second drop-off location constraint for the second rider, and second destination time information associated with the second rider and indicative of a second drop-off time constraint for the second rider; determining a route for the automobile in dependence upon at least: the first origin location information, the first origin time information, the first destination location information, the first destination time information, the second origin location information, the second origin time information, the second destination location information, and the second destination time information; associating the route with a trip; and notifying the first rider and the second rider of at least one of: i) the route, or ii) the trip.

Aspects of the present disclosure include methods for optimizing automobile travel, including identifying a cluster of riders from a plurality of potential riders for shared use of an automobile for travel, the cluster comprising at least a first rider and a second rider of the plurality of potential riders, in dependence upon at least ride constraint information associated with each rider of the plurality of potential riders; determining a route for the cluster in dependence upon at least the first rider constraint information and the second rider constraint information, the route enabling pickup and drop-off of the first rider and the second rider; providing the route to at least one of: i) the automobile, and ii) a device associated with a driver, iii) a device associated with the first rider, iv) a device associated with the second rider.

Some embodiments include a non-transitory computer-readable medium product accessible to a processor and having instructions thereon that, when executed, cause the at least one processor to perform methods described above. System embodiments may include at least one processor and a computer memory accessible to the at least one processor comprising a computer-readable medium having instructions thereon that, when executed, causes the at least one processor to perform methods described above.

Examples of some features of the disclosure may be summarized rather broadly herein in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIGS. 1-3 are diagrams illustrating methods for managing shared automotive travel in accordance with embodiments of the present disclosure;

FIG. 4A is a diagram illustrating a system for managing shared automotive travel in accordance with embodiments of the present disclosure;

FIG. 4B sets forth a block diagram of an example computing device in accordance with embodiments of the present disclosure;

FIGS. 4C & 4D are architecture diagrams illustrating systems for managing shared automotive travel in accordance with embodiments of the present disclosure;

FIG. 5 shows a flow chart illustrating methods for managing shared automotive travel in accordance with embodiments of the present disclosure;

FIG. 6 shows a flow chart illustrating methods for identifying the cluster of riders in accordance with embodiments of the present disclosure;

FIG. 7 shows a flow chart illustrating methods for managing shared automotive travel in accordance with embodiments of the present disclosure.

### DETAILED DESCRIPTION

Aspects of the present disclosure relate to methods and systems for optimizing shared automobile travel, carried out by identifying a cluster of riders suitable for shared automotive travel from a plurality of potential riders. Ride constraint information associated with each rider may be stored in a database. In some aspects, the ride constraint information may be processed to build routes in advance. Riders may have an individualized account, and have access to view and change constraint information associated with the rider (e.g., via the account), for example, through a web browser or dedicated application (‘app’) running on a mobile device or a home computing device connected to a network, or to opt in or opt out of travel on a particular day. Aspects of the disclosure include computer-implemented methods for managing shared automotive travel in dependence upon the constraint information stored in the database.

Millions of cars are employed in daily travel throughout the United States. By one measure, an estimated 114 million people drive alone each day to work. This single rider use of automobiles strains infrastructure, increases household expenses, and expands travel time for all riders during peak travel periods. A Department of Transportation study shows that transportation is the second highest household expenditure. In large urban areas it's not unusual for a trip that normally takes 30 minutes to take 90 minutes during peak hours, again with the predominant number of cars carrying one person. The average daily American commute totals approximately 35 minutes per day (approximately 152 hours). Because each of these users is driving, it is difficult for them to employ the commute period for other practical purposes (e.g., working).

The larger number of cars on the road each day resulting from a lack of shared rides also increases emissions. Each car on the road adds tremendous amounts of carbon dioxide into the atmosphere. The EPA reports that 4.6 metric tons of carbon dioxide is emitted by the average passenger vehicle every year. Negative effects from automobile emissions (e.g., decreases in air quality, health hazards, climate effects) are widely known. The World Health Organization (WHO) has reported that air pollution due to gasoline and diesel emissions from internal combustion engines of automobiles, trucks, locomotives, and ships leads to 800,000 premature deaths annually due to pulmonary, cardiovascular, and neurological complications. Facilitating shared rides between commuters is likely to reduce the number of vehicles needed for commuters to reach their destinations, resulting in reduced volumes of automobile emissions.

Previous solutions to automobile traffic have proven ineffective. Public transport vehicles such as buses and metro reduce the number of cars on the road, but are often either inconvenient or inaccessible for a significant portion of the population. Public transportation systems (e.g., bus systems, light rail systems) are designed to carry large numbers of people, but have a limited number of access points and follow a set schedule.

The ad hoc pick-up personal transport ecosystem is now well-developed, and techniques for arranging transport between riders and drivers through the use of mobile devices and server-based management platforms is well-understood. See, for example, U.S. Pat. No. 4,360,875 issued to Behnke, U.S. Pat. No. 6,697,730 to Dickerson, and U.S. Pat. No. 7,756,633 to Huang et al., U.S. Pat. No. 8,768,614 to Lerenc, U.S. Pat. No. 9,939,279 to Pan et al, U.S. Pat. No. 10,520,325 to Lewinson and Lewinson, U.S. Pat. No. 10,685,416 to Tolkin et al., and U.S. Pat. No. 11,808,588 to Marco, each hereby incorporated by reference in their entirety.

Ride-sourcing services such as Uber and Lyft pick up passengers at a desired point of departure and drop them at a destination. These services often function as a vehicle with a driver and a passenger. In this use case, the number of vehicles used per commuter remains the same. Minor components of existing ride-sourcing services allowing riders with different pick-up and drop-off points to share a segment of the ride tend to be relatively expensive for regular use, and their ad hoc nature results in gross inefficiencies. Further, under these ride-sourcing services, prices will increase at certain times depending on demand, route, and availability of drivers. In fact, drivers can reject requests for certain rides. Unfortunately for planning purposes, the passengers requesting shared rides do not know how long they will wait for the ride, which will depend on availability.

Under some conventional ride-sourcing systems, passengers may indicate a willingness to attempt shared automotive travel. The system searches for potential passengers; however, if there is no one to share the ride with, the passenger rides alone. This again results in a vehicle with a driver and a single passenger.

Carpooling can result in longer commutes and is difficult to arrange. Among the biggest weaknesses of shared rides is connecting passengers. Finding people to share rides with having a geographically aligned commute and a compatible schedule is problematic. Ride-sourcing services randomly select commuters to add to existing rides.

Overall, there is no structured system which connects large volumes of people for shared rides over a wide range of trips. That these challenges are not answered by the current shared ride and carpooling systems is evidenced by the fact that 76% of car owners drive alone.

The innovations embodied by methods and systems of the present disclosure are a substantial improvement over the prior art. Aspects of the disclosure are effective to connect large volumes of people for shared rides. Trips may be assembled in advance for some riders. Embodiments of the disclosure enable provision of a convenient and reliable carpooling system at predetermined prices which do not fluctuate during the day.

Furthermore, aspects of the disclosure result in a continuing reduction of average commute times for its users as adoption increases due to fewer vehicles on the road. Riders may work on their laptops or read while driven to their destination. With readily availability of internet on phones and laptops, passengers can start their day's work while on route to their places of business or wind down with social media or news while being driven home. The innovations described herein provide an entry point for large sectors of the population to effect reduced car exhaust emissions.

### Structured Shared Automotive Travel

Commuting typically involves constraints on a rider. These constraints may include constraints centered around geography or time. Geographical constraints may include the start and end points of the journey, such as the rider's home address and the ultimate destination (e.g., the office where the rider works), or a segment of the journey, such as the rider's home address and a public transport access point or a public transport access point and the ultimate destination. For the commute home, these constraints may be reversed. Geographical constraints may also include information indicative of the distance the rider is willing to walk, bike, or otherwise travel to or from the vehicle for drop-off or pick-up, or specific locations or areas where the rider is willing to be picked up or dropped off. These are constraints because the feasibility and desirability of any particular trip for the rider may depend on them. Likewise, time-based constraints may include the optimal pick-up time, drop-off time, and trip duration, as well as acceptable variations from the optimal values (e.g., values indicative of a pick-up time window).

Structured shared automotive travel identifies clusters of people having sufficiently similar constraints, such that the riders in the cluster are suitable for a shared trip in a vehicle between them. Determining whether the constraints of a set of riders are sufficiently similar may be carried out by determining whether the values for at least one ride constraint parameter meet a similarity threshold for the set of riders.

Aspects of the disclosure enable receipt and storage of a rider's constraints in association with the rider, effected, as one example, by a server receiving and processing requests from various client devices and operatively coupled to a database. A user interface may enable the establishment and management of an account associated with the rider and enable riders to input information including but not limited to mobile telephone numbers; email address; origin location information, such as home street address and zip code; destination address, such as work street address and zip code; the time they need to arrive at destination (e.g., work start times); and desired start time, so as to determine when the rider may be available for pick-up. The start time may allow determination of the number of people available for the ride within a threshold radius distance. The user interface may also enable riders to input information such as work end time, when passengers could be picked up to go home; trip duration constraints, musical preferences, noise level preferences, and so on. The potential passengers may also indicate parameters indicative of their level of flexibility for each time constraint (e.g.,, number of minutes before or after the preferred work start time and/or end time that are acceptable), or the constraint may comprise a time window, and/or parameters indicative of their level of flexibility for each geographical constraint (e.g., number of miles away from destination where drop-off would be acceptable) or an acceptable area for drop-off. When the processor determines the pickup and drop off times, the levels of time flexibility in turn expands the window of potential passengers that can be grouped in a shared ride schedule.

One benefit of the present disclosure is to shorten commute times from self-driving commutes by connecting larger volumes of people for shared rides, resulting in a reduction of cars on the road. As the techniques of the disclosure are adopted, average commute times drop. The innovation of the present disclosure provides a unique approach to transportation coupled with reduction of carbon emissions currently not achievable on large scale.

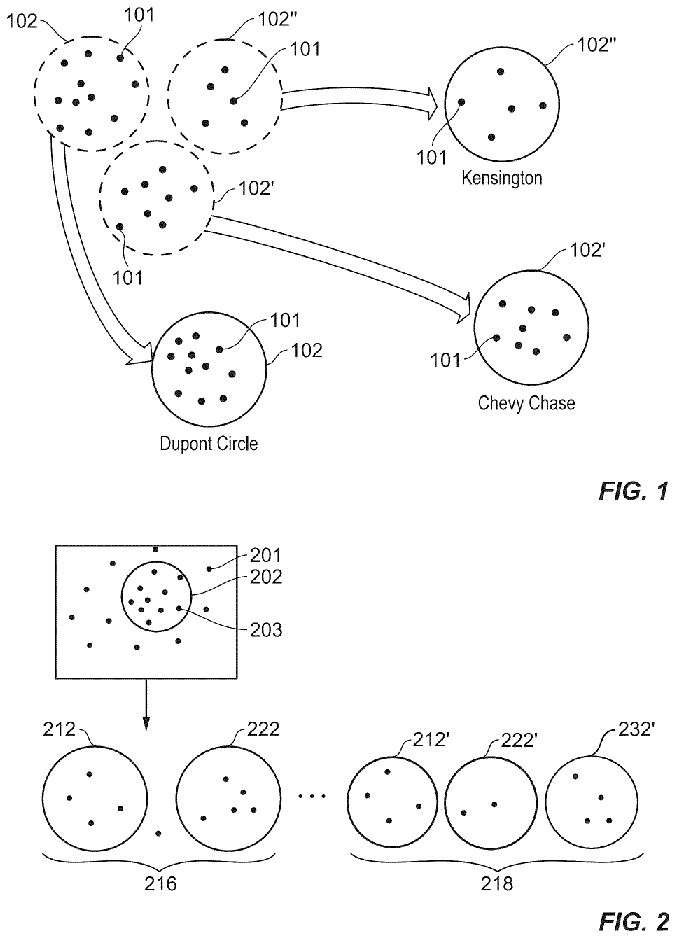

FIGS. 1-3 are diagrams illustrating methods for managing shared automotive travel in accordance with embodiments of the present disclosure. FIG. 1 depicts geographic locations of riders 101 from a rider database allocated to clusters (102, 102′, 102″), such that each rider 101 in a cluster both lives and works sufficiently closely to the other riders in the cluster such that the collection of riders in the cluster is suitable for shared automobile travel (e.g., the commute to a destination for work).

In one example, a clustering process generates a preliminary cluster of riders traveling from origin points close to one another at a general time of day. For example, these people may live in homes close to one another in the same neighborhood or adjacent neighborhoods. A preliminary cluster may be established through various clustering techniques as discussed in greater detail below.

The riders in the database may be presorted or filtered prior to clustering, such as, for example, by using five-or nine-digit zip codes associated with each rider or the like or by using previous clustering results or other methods to categorize rider origin and/or destination locations (e.g., street addresses or coordinates) into regions, sub regions, and/or local levels. This preliminary cluster may then be processed to establish a central location and discard riders in the preliminary cluster who live outside of a set threshold distance, such as a radius from the central location or the distance to the nearest neighbor of the cluster (e.g., 1 mile). The discarded riders may be analyzed for addition to an adjacent cluster, or to a cluster having trips of a longer duration. The threshold radius may be modified in dependence upon the number of candidate riders in the region. As more riders join in the same region, clusters may be reduced in size geographically to increase efficiency. Conversely, if adjacent regions are sparsely populated with candidate riders (or if a threshold number of regions is sparsely populated), as measured against a minimum number of candidates, then clusters may be increased in size.

For example, in certain method embodiments, identifying the cluster may include identifying people who start travel (e.g., have a home address) within a certain threshold radius from a common geographical location as well as having a destination within a particular threshold radius from another common geographical location. In some aspects, geospatial clustering (e.g., partition clustering) may be used to allocate a set of riders in spatially distributed locations into groups called “clusters”, where riders within a cluster show a high degree of constraint similarity. K-means clustering, K-medoids clustering (‘PAM’), and CLARA (Classification Large Application) clustering may be used, either alone or in combination with each other, or in combination with other clustering algorithms, to generate the cluster of riders. Areas may be further subdivided or concatenated to find a number of riders in the cluster within a target range.

FIG. 2 illustrates a clustering process in accordance with embodiments of the present disclosure. Riders 201 from a first geographic area, such as a zip code, range of geographic coordinates, towns, and so on, and leaving at the same time are identified in a database and constraint information in the database is accessed and processed to identify a first preliminary cluster 202 of riders having origin constraints meeting a similarity threshold. Identifying the first preliminary cluster may include, for example, generating trial clusters and testing these clusters against one or more rules or against other clusters. One method of generating trial clusters is to geographically subdivide the larger geographical area into units that contain riders distributed in an area that is smaller than the distribution threshold (e.g., a circle of one mile radius).

Riders of the resulting first preliminary cluster 202 may carpool if they work sufficiently closely to each other. In the current example, a clustering process generates a second preliminary cluster 212′ of riders 203 in the first cluster traveling to destination points close to one another (as well as other second preliminary clusters 222′, 232′ of riders) with methods similar to those used to generate the first preliminary cluster. By iteratively processing the pool of riders, multiple clusters may be generated, with each cluster having a plurality of riders. In this case, the process includes generating multiple sets (216, 218) of second preliminary clusters, and using a scoring algorithm to select the most preferred set (e.g., most efficient, timely, fewest riders left outside a cluster, etc., or combinations of these). Various selection rules may be employed to select the second preliminary clusters. While set 218 includes three clusters (212′, 222′, 232′), set 216 includes only two clusters (212, 222).

Once a cluster has been identified, a route to the destination (e.g., a workplace) may be determined. An arrival time window for each rider 201 in clusters 212′, 222′, and 232′ is confirmed against projected estimated time of arrival (ETA) as calculated by systems of the disclosure. Set 218 is selected as the cluster of riders from which riders will be assigned to a trip. Sets may be selected in accordance with selection rules. Set 218 is selected due to having sufficient efficiency, as described in further detail below, as well as leaving no riders from the first preliminary cluster 202 outside a secondary cluster, and not violating arrival time window constraints. In variations, additional processing of the second preliminary cluster may organize riders in the second cluster in dependence on time constraints.

In other embodiments, all the riders in the cluster may be assigned to the same vehicle, or a subset of riders may be assigned to a vehicle based on various assignment algorithms such as offer and acceptance for riders in the cluster based on a first come-first serve basis, least cost algorithms, personality profile compatibility, and so on. A route may be determined for the selected riders in the vehicle. In some instances, multiple preliminary routes may be first generated for riders in the cluster or various subsets of the cluster, in order to determine a preferred route. Thus, determining the route and the subset may occur iteratively and in any order. In some cases, a driver or a vehicle may be assigned to a trip based on the number of selected riders by using a vehicle matching algorithm.

Clusters may be seeded by identifying a rider in the database in any fundamental geographic area (e.g., zip code). Each cluster is given a unique identifier. As additional riders are added to the database they may be tested against existing clusters centered on existing riders. If the additional rider is within the geographic threshold of the current cluster (e.g., a 1 mile radius), the rider is added to the cluster by associating the cluster identifier with the rider in the database. If outside the cluster, a new cluster is created.

FIG. 3 depicts alternative methods in accordance with the present disclosure. Clusters 312 are non-exclusive clusters. Sets of riders may be formed by offering riders a choice to claim a spot in any cluster. Each rider may be the center of its own cluster when entered into the database. A search for nearby riders (e.g., origin locations within a predefined radius of the origin location of the user) may be conducted, and each rider may be associated with the cluster identifier corresponding to the nearby rider in the database and a lookup table may be created listing all the members of each cluster. Preliminary trips from each cluster with a corresponding route may be planned at regular intervals.

Riders 301 within each cluster 312 are notified of the route 314 and allowed to claim a spot on a vehicle selection via a graphical user interface or added automatically in dependence upon configuration data associated with the rider in the database. A minimum number of riders from the cluster may be needed for the route to become active. A deadline may be set in advance of the pick-up time for the route to become active. When the route becomes active, a notification is sent to the riders and associated drivers. Drivers then attempt rider pick-up and drop-off the corresponding riders along the route at the prescribed time.

In other aspects, once the route is established, methods of the disclosure may include identifying potential riders 313 (e.g., outside the cluster) having a desired pick-up or drop-off location along the route (or within a threshold distance) with compatible time constraints to be prospectively added to the trip. Auxiliary riders 313 who live within a threshold distance to the route may be added to the trip if any required change in the route does not violate the time constraints of the riders. The addition of auxiliary riders may be carried out by notifying qualifying riders and adding the rider in response to selection via a graphical user interface or carried out automatically in dependence upon configuration data associated with the rider in the database. Riders 313′ who live within a larger second threshold distance 335 to the route may be similarly added to the trip by selecting an acceptable rendezvous point that does not violate the time constraints of the riders. Some methods allow passengers to create their own shared ride trips such as to concerts, shopping, the beach, and so on.

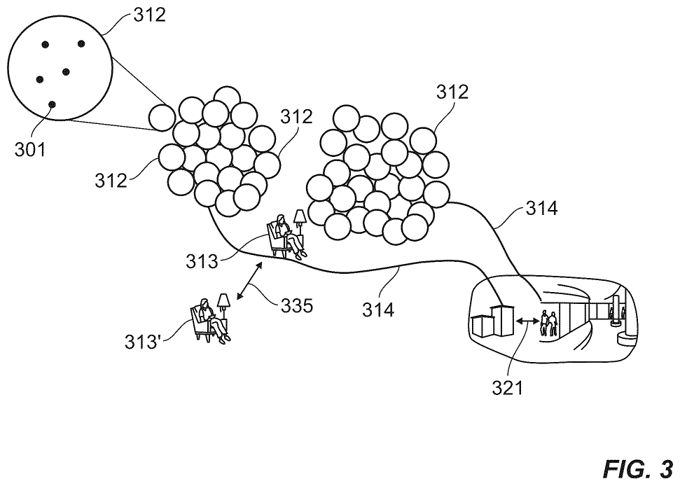

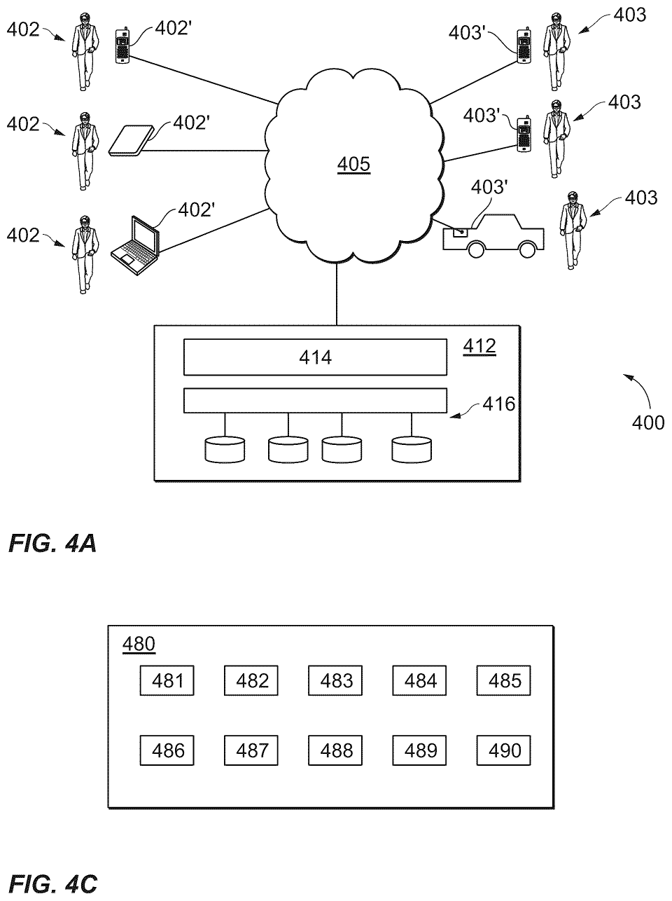

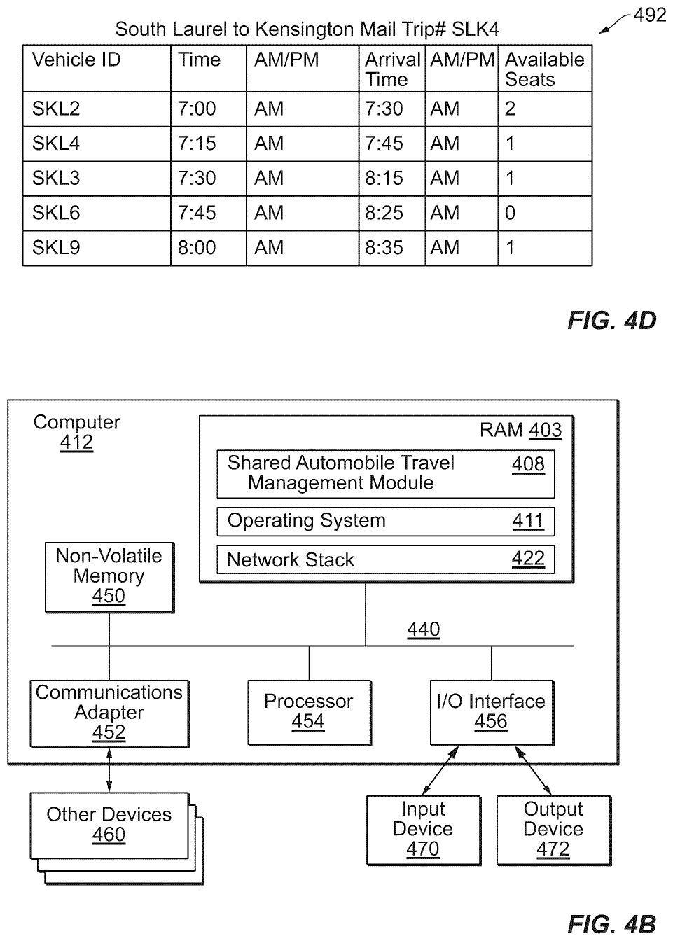

FIG. 4A is a diagram illustrating a system for managing shared automotive travel in accordance with embodiments of the present disclosure. FIG. 4A schematically illustrates a system 400 configured to implement the methods described hereinbelow with riders 402 having computing devices 402′ and drivers 403 having computing devices 403′. Computing devices 402′ & 403′ may be any of mobile telephones, smartwatches, tablets, laptops, smart televisions, desktops, vehicle computing systems, intelligent virtual assistants (IVAs), intelligent personal assistants (IPAs), other cellular devices, or any other type of information processing device. Network 405 may be implemented to include any combination of wired and/or wireless connections. The computing devices are coupled via one or more networks 405 to shared automotive management platform 412. Shared automotive management platform 412 may be one or more servers 414 and backend systems 416 and implemented as a distributed computing platform.

FIG. 4B sets forth a block diagram of an example computing device used in embodiments of the present disclosure. Computer 412 includes at least one computer processor 454 as well as a computer memory, including both volatile random access memory (‘RAM’) 403 and some form or forms of non-volatile computer memory 450 such as a hard disk drive, an optical disk drive, or an electrically erasable programmable read-only memory space (also known as ‘EEPROM’ or ‘Flash’ memory). The computer memory is connected through a system bus 440 to the processor 454 and to other system components. Thus, the software modules are program instructions stored in computer memory.

An operating system 411 is stored in computer memory. Operating system 411 may be any appropriate operating system such as Windows 10, Windows 11, Mac OSX, UNIX, or LINUX. A network stack 422 is also stored in memory. The network stack 422 is a software implementation of cooperating computer networking protocols to facilitate network communications.

Computer 402′ also includes one or more input/output interface adapters 456. Input/output interface adapters 456 may implement user-oriented input/output through software drivers and computer hardware for controlling output to output devices 472 such as computer display screens, as well as user input from input devices 470, such as keyboards and mice.

Computer 402′ also includes a communications adapter 452 for implementing data communications with other devices 460. Communications adapter 452 implements the hardware level of data communications through which one computer sends data communications to another computer through a network.

Also stored in computer memory is a shared automotive travel management module 408. The shared automotive travel management module 408 may include device-specific computer program instructions for implementing methods as described hereinbelow. Shared automotive travel management module 408 may be implemented, in part, as a web browser, email client application, or dedicated purpose application running on a desktop, smartphone, or workstation operated by a driver or potential rider. Alternatively, shared automotive travel management module 408 may comprise an integrated system application with modules running on multiple coordinated processors. Shared automotive travel management module 408 may also be implemented, in part, as server applications running on an application server and data storage management systems, including database management systems (DBMS) such as MySQL, Microsoft SQL Server, Oracle, MongoDB, MariaDB, and so on.

FIG. 4C is an architecture diagram illustrating a system for managing shared automotive travel in accordance with embodiments of the present disclosure. Cloud-based system architecture 480 includes logic modules configured to carry out methods of the present disclosure. A processor runs a Module 1 (481) configured to reductively integrate riders meeting certain constraints, such as, for example, living within a specified radius and working within a specified radius. The processor further divides these riders into categories based on additional constraint(s), such as work start time. Work time flexibility levels will enable enlarging the groups for the people within the same work start time. The resulting cluster includes riders having similarity in all criteria who are candidates to share rides.

The processor may determine who should be dropped first based prioritization such as work start time or effective travel distance, or pay more to be dropped first. Likewise, the processor groups people within the specified work radius based on work end time. The processor will determine the order of picking the person based on several criteria. The passengers can wait in the comfort of their homes and track the shared ride as it comes to their doorsteps. As described above, in some instances, geographic thresholds for inclusion in a cluster can be dynamic if the processor determines that the criteria such as time to be at final destination and price are met.

A Processor runs module 2 (Monitoring controller 1, 482) configured to perform a dynamic process with constant monitoring to adjust configurations (e.g., thresholds) in dependence on the number of active users. As more people sign up, this enables the shortening of pick up and drop off radius and subsequently even shorter times to work and home. Likewise, if fewer riders are active in the program, techniques of the disclosure may lengthen the threshold radius. If at the time of sign-up, there are not enough riders in an area to arrange a shared ride, Module 3 (Monitoring controller 2, 483) will keep records of applicants and inform if more people sign up for a route of interest. This allows the passengers to input their constraint information, including addresses to be picked up, destination address, pick up time, and desired drop off point. The processor will match to see if a shared ride is available within that time span. Module 3 enables passengers to have real time access to the distance of the driver from them and estimated time of the driver arrival using interface devices such as cellphones.

Scheduling is carried out by Module 4 (484). In large population centers, there can be many people within a specified radius at point of departure and subsequently the drop-off point. These people may have configuration information representing start times within a range of times or other representations of time flexibility. As a result, the processor will compute routes for several departure times. Referring to FIG. 4D, for example, a schedule 492 is presented to the rider showing trips with origination times at 7:00 AM, 7:15 AM, 7:30 AM, 7:45 AM and 8:00 AM along with other pertinent information, such as the number of seats left available. Passengers may confirm acceptance of shared rides at one of many departure times within the available departure time range span. This further allows more people to participate in the shared rides programs. The system will indicate how much space is available on each ride, such that if one passenger misses their ride, they can check availability on the next ride.

Returning to FIG. 4D, Module 5 (485) is configured for monitoring the size of vehicles carrying the passengers and the number of passengers in each vehicle. In the event that rider misses the vehicle, the module is configured for passengers to check when the next trip is and if there is space in that vehicle. Only people on an identified route may be able to see the available seats within the selected times.

Module 6 (486) is configured for enabling potential riders to enter their desired point of origin and desired destination and query available rides and available times of the rides in their cluster. This could enable passengers with flexible work schedules or flexible schedules on their trips to make necessary adjustments.

The destination may be a waypoint or a station for connecting to other forms of transportation (e.g., a subway or light rail stop). The module may determine when passengers cannot be dropped at work due to a threshold destination distance being exceeded. The module may be configured to determine how long it would take them to get to work by taking a trip to an alternate transportation station and then taking the alternate transportation to the destination by using an integrated transportation schedule for the alternate transportation.

Once routes are established, the module determines additional passengers with pick-up or drop-off along the route who can be added to the ride if additional constraints (e.g., drop-off time and price) are met. Unlike other modern ride-sourcing systems, where processors determine the best routes for each ride, methods of the present disclosure may utilize a route that becomes relatively fixed ahead of time (e.g., a set period of time prior to the trip or after a threshold number of passengers are committed to the ride) to enable picking up passengers along the way.

Once the routes are established, the routes are made available for drivers to sign up and provide driver services. In contrast to prior art, passengers may also sign up as drivers on particular routes they are on. Routes may be made available to drivers based on specifications of an associated vehicle, such as interior or exterior dimensions or number of seats. Vehicle specification determination may depend on several factors including the number of passengers to share the ride.

Module 7 (487) is configured to implement subsidization. Reduced cars on the roads are of interest to several organizations including city governments. Should city governments provide subsidies to the shared ride program, this may be factored in the cost of operations to reduce the overall cost to the riders. Module 7 may be configured to compute the modified cost for the riders based on contributions or subsidies from city governments. Passengers serving as drivers may be remunerated differently than non-passenger drivers.

Module 8 (488) is configured to provide system alternative in the case that the passenger has missed or will miss the ride. In the event that a passenger is late, they may cancel the ride (e.g., use their own transportation) or request an individual ride at an extra charge.

Module 9 (489) is configured to transact payment for system use. On a subscription basis, payments for the shared rides may be made in advance on a set schedule (e.g., monthly). This enables the passengers to know the price they are paying well ahead of time.

Module 10 (490) is configured for user interface monitoring. User interface monitoring may provide statistics comprising but not limited to: real time data on estimated number of cars not used in commuting due to ride sharing; estimate total number of cars not used in commuting that day due to ride sharing; estimated total travel distance saved that day through ride sharing; estimated carbon emissions saved by a rider on a particular ride; estimated total carbon emission saved that day through ride sharing; one or more cumulative statistics related to estimated distances and estimated carbon emission saved over time.

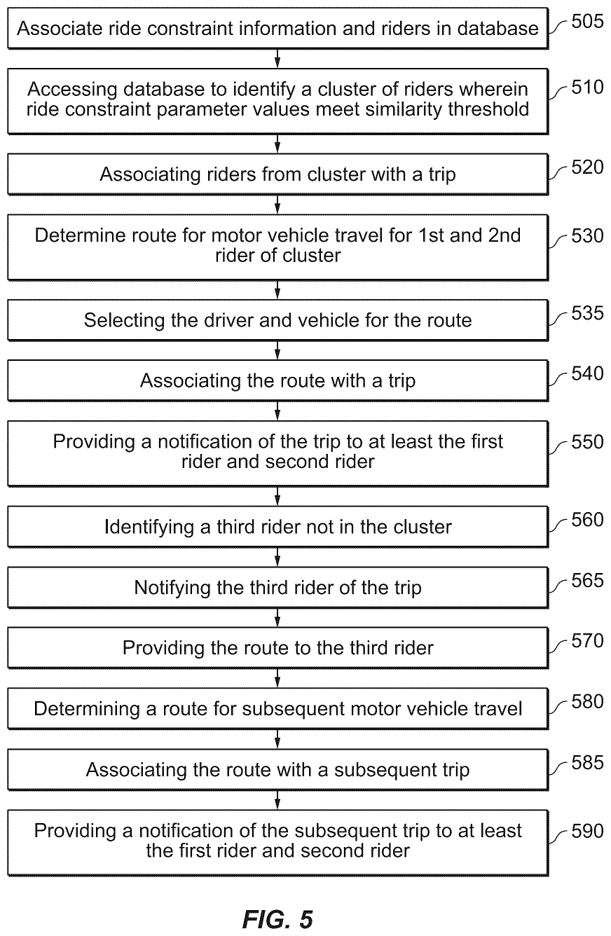

FIG. 5 shows a flow chart 500 illustrating methods for managing shared automotive travel in accordance with embodiments of the present disclosure. In optional step 505, ride constraint information for each rider of a plurality of potential riders is associated with the rider in a database. The ride constraint information for each rider may include a value for at least one ride constraint parameter.

Step 510 is carried out by accessing the database associating ride constraint information with each rider of a plurality of potential riders to identify a cluster of riders from the plurality of potential riders wherein the values for the at least one ride constraint parameter for the cluster of riders meet a similarity threshold. The similarity threshold may be implicitly implemented via design of the clustering process or explicitly enforced via filtering techniques or the like (e.g., post clustering). The similarity threshold may comprise a value associated with a similarity metric, such as, for example, the difference in successive iterations output from a clustering algorithm (e.g., difference in successive centroid locations in a k-means clustering algorithm), average distance to closest neighbor, maximum distance from the average location, combinations of these, location based functions, and so on. The similarity metric may be calculated as a function of one or more of the rider positions or may involve more complex methodologies.

As an example, in k-means clustering, for every cluster, an algorithm recomputes the centroid by taking the average of all points in the cluster, reducing the total intra-cluster variance in relation to the previous step, followed by re-assignment of locations to the closest centroid. Methods in accordance with the present disclosure may repeat the calculation of centroids and assignment of points until the sum of distances between the data points and their corresponding centroid (aggregate distribution distance) reaches an aggregate distance threshold or the difference in successive centroid locations or aggregate distribution distances decrease to a point where an iterative change threshold is reached. Successive iterations may substantially match when they differ by less than a threshold amount (i.e., the similarity threshold), such as, for example, a cost function (e.g., least squares optimization), which may be expressed in absolute or percentage difference terms (e.g., less than 5 percent difference, less than 2 percent difference, less than 1 percent difference, less than 0.1 percent difference, and so on).

Optional step 520 includes associating riders from the cluster with a trip. Methods in accordance with the present disclosure may include selecting riders from the cluster in dependence upon rider selection rules and/or a selection score associated with each rider in the cluster, and so on, while limiting the number of passengers for a particular vehicle in dependence upon configuration data for the vehicle. The selection score may be determined from a weighted combination of stored parameter values, such as values corresponding to request duration, duration of account membership, distance from center of the cluster, distance from destination, and so on.

Step 530 includes determining a route for a motor vehicle travel for at least a first rider and a second rider of the cluster in dependence upon at least the value for the at least one ride constraint parameter associated with the first rider and the value for the at least one ride constraint parameter associated with the second rider. The route may be determined as the shortest route from each vehicle (along with, in some cases, associated drivers) within a threshold distance of the cluster. For example, shortest path algorithms may examine all possible routes (from each vehicle) and calculate the distance and/or time for each. Systems described herein may be configured to select the route with the lowest cost. In embodiments, multiple routes may be estimated and cost functions calculated before an optimal route is determined.

Optional step 535, which may be optionally carried out prior to or after step 530, includes selecting the driver and vehicle for the route. Vehicles may also be pre-filtered or weighted according to configuration data associated with riders or particular locations. In embodiments, route, driver, and passengers may be iteratively selected. Step 540 includes associating the route with a trip.

Step 550 comprises providing a notification of the trip to at least the first rider and the second rider. Notification may be carried out by changing values in a database accessible through a user interface communicating with a server as described hereinabove, or by sending texts, emails, or in-app communications. Optionally, the route may be provided to at least the first rider and the second rider of the trip, to the driver, and/or to a vehicle associated with the trip.

Optional step 560 includes identifying a third rider not in the cluster from the plurality of potential riders that is within a distance metric threshold of the route. Identifying whether the third rider is within the distance metric is carried out in dependence upon ride constraint information in the database associated with the third rider. Optional step 565 comprises notifying the third rider of the trip. In optional embodiments, the system may associate the third rider with the trip, either automatically or in response to positive selection by the rider after the rider is notified. The rider may prevented from accepting if no unclaimed spots are left in the vehicle (the vehicle is full). Optional step 570 comprises providing the route to the third rider.

Optional step 580 comprises determining a route for subsequent motor vehicle travel for at least the first rider and the second rider in dependence upon at least the value for the at least one ride constraint parameter associated with the first rider and the value for the at least one ride constraint parameter associated with the second rider. Optional step 585 comprises associating the route with a subsequent trip. The subsequent trip may be a return trip. Optional step 590 comprises providing a notification of the subsequent trip to at least the first rider and the second rider.

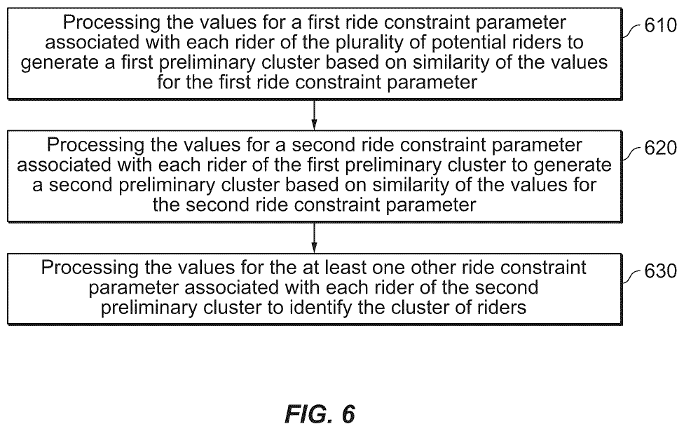

FIG. 6 shows a flow chart 600 illustrating methods for identifying the cluster of riders in accordance with embodiments of the present disclosure. Step 610 comprises processing the values for a first ride constraint parameter associated with each rider of the plurality of potential riders to generate a first preliminary cluster based on similarity of the values for the first ride constraint parameter.

Step 620 comprises processing the values for a second ride constraint parameter associated with each rider of the first preliminary cluster to generate a second preliminary cluster based on similarity of the values for the second ride constraint parameter.

Step 630 comprises processing the values for the at least one other ride constraint parameter associated with each rider of the second preliminary cluster to identify the cluster of riders.

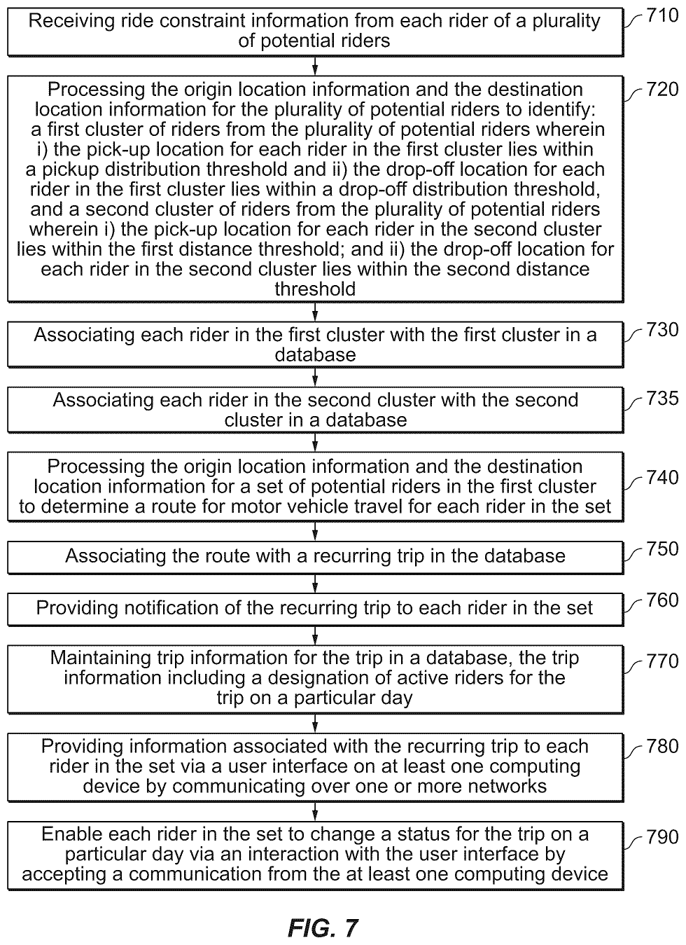

FIG. 7 shows a flow chart 500 illustrating methods for managing shared automotive travel in accordance with embodiments of the present disclosure. Step 710 comprises receiving ride constraint information from each rider of a plurality of potential riders. The ride constraint information for each rider may include origin location information indicative of a pick-up location for a recurring automobile ride and destination location information indicative of a drop-off location for the recurring automobile ride.

Step 720 is carried out by processing the origin location information and the destination location information for the plurality of potential riders to identify: a first cluster of riders from the plurality of potential riders wherein i) the pick-up location for each rider in the first cluster lies within a pickup distribution threshold and ii) the drop-off location for each rider in the first cluster lies within a drop-off distribution threshold, and a second cluster of riders from the plurality of potential riders wherein i) the pick-up location for each rider in the second cluster lies within the first distance threshold; and ii) the drop-off location for each rider in the second cluster lies within the second distance threshold. The pickup distribution threshold may include at least one of: i) a first distance threshold, and ii) a first time threshold, and the drop-off distribution threshold may include at least one of: i) a second distance threshold, and ii) a second time threshold.

Step 730 comprises associating each rider in the first cluster with the first cluster in a database. Step 735 comprises associating each rider in the second cluster with the second cluster in the database. Step 740 comprises processing the origin location information and the destination location information for a set of potential riders in the first cluster to determine a route for motor vehicle travel for each rider in the set. Step 750 comprises associating the route with a recurring trip in the database. Step 760 comprises providing a notification of the recurring trip to each rider in the set.

Step 770 comprises maintaining trip information for the trip in a database, the trip information including a designation of active riders for the trip on a particular day. Step 780 comprises providing information associated with the recurring trip to each rider in the set via a user interface on at least one computing device by communicating over one or more networks. Step 790 comprises enabling each rider in the set to change a status for the trip on a particular day via an interaction with the user interface by accepting a communication from the at least one computing device.

System embodiments in accordance with the foregoing can arrange a ride provided by a driver for a selected subset of the cluster (e.g., a first rider and a second rider). The system can arrange a ride provided by a driver for the first rider and the second rider. For example, the system can make this determination based, at least in part, in dependence upon a first pick-up location of the first user, a second pick-up location of the second user, a first destination location of the first user, and a second destination location of the second user.

Implicit in the control and processing of information is the use of a computer program on a suitable non-transitory machine readable medium that enables the processors to perform the control and processing. The non-transitory machine readable medium may include ROMs, EPROMs, EEPROMs, flash memories and optical disks. The term processor is intended to include devices such as a field programmable gate array (FPGA).

The term “information” as used above includes any form of information (analog, digital, EM, printed, etc.). The term “processor” or “information processing device” herein includes, but is not limited to, any device that transmits, receives, manipulates, converts, calculates, modulates, transposes, carries, stores or otherwise utilizes information. Implicit in the control and processing of the data is the use of a computer program on a suitable non-transitory machine readable medium that enables the processors to perform the control and processing. An information processing device may include a processor, resident memory, and peripherals for executing programmed instructions. In several non-limiting aspects of the disclosure, an information processing device includes a computer that executes programmed instructions for performing various methods. These instructions may provide for equipment operation, control, data collection and analysis, and/or other functions in addition to the functions described in this disclosure. The processor may execute instructions stored in computer memory accessible to the processor, or may employ logic implemented as field-programmable gate arrays (‘FPGAs’), application-specific integrated circuits (‘ASICs’), other combinatorial or sequential logic hardware, and so on. Thus, a processor may be configured to perform one or more methods as described herein, and configuration of the processor may include operative connection with resident memory and peripherals for executing programmed instructions.

Method diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

“Clustering,” as used hereinabove, refers to any process to find riders having significantly similar ride constraints, and may be carried out by processes including traditional clustering methods such as, for example, partition clustering, hierarchical clustering, fuzzy clustering, density-based clustering, model-based clustering, rule based geographic segmentation, and so on. A “cluster,” as used hereinabove, refers to a set of riders having at least one significantly similar riding constraint such that they are candidates for a shared ride in an automobile.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The terms “first”, “second”, “third” and the like are used to distinguish elements and are not used to denote a particular order.

While the foregoing disclosure is directed to the one mode embodiments of the disclosure, various modifications will be apparent to those skilled in the art. It is intended that all variations be embraced by the foregoing disclosure. The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A computer-implemented method for managing shared automotive travel, the method being performed by one or more processors and comprising:
accessing a database associating ride constraint information with each rider of a plurality of potential riders, the ride constraint information for each rider comprising a value for at least one ride constraint parameter, to identify a cluster of riders from the plurality of potential riders wherein the values for the at least one ride constraint parameter from the associated ride constraint information for the cluster of riders meet a similarity threshold;
determining a route for motor vehicle travel for at least a first rider and a second rider of the cluster in dependence upon at least the value for the at least one ride constraint parameter associated with the first rider and the value for the at least one ride constraint parameter associated with the second rider;
associating the route with a trip; and
providing a notification of the trip to at least the first rider and the second rider.

2. The method of claim 1, further comprising identifying a third rider not in the cluster from the plurality of potential riders that is within a distance metric threshold of the route in dependence upon ride constraint information in the database associated with the third rider, and notifying the third rider of the trip.

3. The method of claim 1, further comprising identifying a third rider not in the cluster from the plurality of potential riders that is within a distance metric threshold of the route in dependence upon ride constraint information in the database associated with the third rider, and providing the route to the third rider.

4. The method of claim 1, wherein the value for the at least one ride constraint parameter comprises a value for a first ride constraint parameter, a value for a second ride constraint parameter, and a value for at least one other ride constraint parameter, and wherein identifying the cluster of riders comprises:
processing the values for the first ride constraint parameter associated with each rider of the plurality of potential riders to generate a first preliminary cluster based on similarity of the values for the first ride constraint parameter;
processing the values for the second ride constraint parameter associated with each rider of the first preliminary cluster to generate a second preliminary cluster based on similarity of the values for the second ride constraint parameter; and
processing the values for the at least one other ride constraint parameter associated with each rider of the second preliminary cluster to identify the cluster of riders.

5. The method of claim 1, further comprising:
determining a route for subsequent motor vehicle travel for at least the first rider and the second rider in dependence upon at least the value for the at least one ride constraint parameter associated with the first rider and the value for the at least one ride constraint parameter associated with the second rider;
associating the route with a subsequent trip; and
providing a notification of the return trip to at least the first rider and the second rider.

6. The method of claim 1, wherein determining the route comprises determining the route for a subset of the cluster in dependence upon at least upon ride constraint information associated with each rider of the subset.

7. The method of claim 1, wherein determining the route comprises determining the route for the cluster in dependence upon at least upon ride constraint information associated with each rider of the cluster.

8. The method of claim 1, wherein the constraint information comprises:
first origin location information associated with a first rider of the plurality of potential riders and indicative of a first pickup location constraint for the first rider;
first origin time information associated with the first rider and indicative of a first pickup time constraint for the first rider;
first destination location information associated with the first rider and indicative of a first drop-off location constraint for the first rider;
first destination time information associated with the first rider and indicative of a first drop-off time constraint for the first rider;
second origin location information associated with a second rider of the plurality of potential riders and indicative of a second pickup location constraint for the second rider;
second origin time information associated with the second rider and indicative of a second pickup time constraint for the second rider;
second destination location information associated with the second rider and indicative of a second drop-off location constraint for the second rider; and
second destination time information associated with the second rider and indicative of a second drop-off time constraint for the second rider.

9. The method of claim 1, further comprising providing at least one metric to at least one rider in the cluster, the metric including at least one of: i) estimated cumulative money saved by using the method, ii) a number of cars indicative of an estimated reduction in traffic, and iii) an estimated reduction in automotive emissions.

10. A computer-implemented method for managing shared automotive travel, the method comprising:
accessing a database associating ride constraint information with each rider of a plurality of potential riders to identify a cluster of riders for shared use of an automobile from the plurality of potential riders in dependence upon first ride constraint information for a first rider and second ride constraint information for a second rider;
determining a route for the automobile in dependence upon the first ride constraint information and the second ride constraint information;
associating the route with a trip;
identifying a third rider from the plurality of potential riders that is within a distance metric threshold of the route in dependence upon ride constraint information associated with the third rider; and
providing a notification of the trip to at least the first rider, the second rider, and the third rider.

11. The method of claim 10, wherein the constraint information comprises:
first origin location information associated with a first rider of the plurality of potential riders and indicative of a first pickup location constraint for the first rider;
first origin time information associated with the first rider and indicative of a first pickup time constraint for the first rider;
first destination location information associated with the first rider and indicative of a first drop-off location constraint for the first rider;
first destination time information associated with the first rider and indicative of a first drop-off time constraint for the first rider;
second origin location information associated with a second rider of the plurality of potential riders and indicative of a second pickup location constraint for the second rider;
second origin time information associated with the second rider and indicative of a second pickup time constraint for the second rider;
second destination location information associated with the second rider and indicative of a second drop-off location constraint for the second rider; and
second destination time information associated with the second rider and indicative of a second drop-off time constraint for the second rider.

12. A computer-implemented method for managing shared automotive travel, the method comprising:
accessing a database associating ride constraint information with each rider of a plurality of potential riders to identify a cluster of riders for shared use of an automobile from the plurality of potential riders in dependence upon constraint information comprising:
first origin location information associated with a first rider of the plurality of potential riders and indicative of a first pickup location constraint for the first rider;
first origin time information associated with the first rider and indicative of a first pickup time constraint for the first rider;
first destination location information associated with the first rider and indicative of a first drop-off location constraint for the first rider;
first destination time information associated with the first rider and indicative of a first drop-off time constraint for the first rider;
second origin location information associated with a second rider of the plurality of potential riders and indicative of a second pickup location constraint for the second rider;
second origin time information associated with the second rider and indicative of a second pickup time constraint for the second rider;
second destination location information associated with the second rider and indicative of a second drop-off location constraint for the second rider; and
second destination time information associated with the second rider and indicative of a second drop-off time constraint for the second rider;
determining a route for the automobile in dependence upon at least:
the first origin location information;
the first origin time information;
the first destination location information;
the first destination time information;
the second origin location information;
the second origin time information;
the second destination location information; and
the second destination time information;
associating the route with a trip;
identifying a third rider from the plurality of potential riders that is within a distance metric threshold of the route in dependence upon ride constraint information associated with the third rider; and
providing a notification of the trip to at least the first rider, the second rider, and the third rider.

13. A computer-implemented method for managing shared automotive travel, the method being performed by one or more processors and comprising:
receiving ride constraint information from each rider of a plurality of potential riders, the ride constraint information for each rider comprising origin location information indicative of a pick-up location for a recurring automobile ride and destination location information indicative of a drop-off location for the recurring automobile ride;
processing the origin location information and the destination location information for the plurality of potential riders to identify:
a first cluster of riders from the plurality of potential riders wherein i) the pick-up location for each rider in the first cluster lies within a pickup distribution threshold and ii) the drop-off location for each rider in the first cluster lies within a drop-off distribution threshold, and
a second cluster of riders from the plurality of potential riders wherein i) the pick-up location for each rider in the second cluster lies within a pickup distribution threshold;
and ii) the drop-off location for each rider in the second cluster lies within a drop-off distribution threshold; and
associating each rider in the first cluster with the first cluster in a database;
associating each rider in the second cluster with the second cluster in the database.

14. The computer-implemented method of claim 13 wherein:
the pickup distribution threshold comprises at least one of: i) a first distance threshold, and ii) a first time threshold, and the drop-off distribution threshold is at least one of: i) a second distance threshold, and ii) a second time threshold.

15. The computer-implemented method of claim 13 further comprising:
processing the origin location information and the destination location information for a set of potential riders in the first cluster to determine a route for motor vehicle travel for each rider in the set;
associating the route with a recurring trip in the database; and
providing a notification of the recurring trip to each rider in the set.

16. The computer-implemented method of claim 13 further comprising:
maintaining trip information for the trip in a database, the trip information including a designation of active riders for the trip on a particular day;
providing information associated with the recurring trip to each rider in the set via a user interface on at least one computing device by communicating over one or more networks;
enabling each rider in the set to change a status for the trip on a particular day via an interaction with the user interface by accepting a communication from the at least one computing device.
